(19) United States
(12) Patent Application Publication
(10) Pub. No.: US 2001/0042791 A1
(43) Pub. Date: Nov. 22, 2001

(54) PERSONAL BAR CODE READER APPARATUS AND METHOD

(76) Inventor: WILLIAM MARC POSTLEWAITE, TARPON SPRINGS, FL (US)

Correspondence Address: SMITH & HOPEN PA, 15950 BAY VISTA DRIVE, SUITE 220, CLEARWATER, FL, 33760

(21) Appl. No.: 09/307,234

(22) Filed: May 7, 1999

(51) Int. Cl. G06K 7/10

(52) U.S. Cl. 235/462.25

(57) ABSTRACT

A personal hand held bar code reading and storage device having a bar code scanner, a read-only memory module, a microprocessor, a non-volatile memory module to store scanned bar codes, and software to compare scanned bar codes with stored bar codes and a light, LED, alphanumeric display, or sound device to alert user when a match is detected in the scanned bar code and a previously stored bar code.

### FIELD OF INVENTION

The present invention relates generally to a personal hand-held bar code reading device that reads and stores bar codes in an internal memory and compares the bar codes to other bar codes previously stored in the device by the user.

### BACKGROUND OF THE INVENTION

Because of the abundance of products available on the market today, manufacturers, distributors, wholesalers, and retailers utilize standard bar codes to identify and keep inventory. Today, most products in the industrialized world have bar codes printed on the product packages or on the products themselves. While bar codes were originally developed for use in grocery stories, the technology is prevalent in many other industries and organizations. Researchers have mounted tiny bar codes on bees to track the insects' mating habits. The United States Army uses two-foot-long bar codes to label fifty-foot boats in storage at West Point. Hospital patients wear bar-code ID bracelets. The codes appear on truck parts, business documents, shipping cartons, marathon runners, and even logs in lumberyards. These bar codes are read by bar code readers and are generally read when putting new products into inventory or removing products from inventory. In either case, the reader generally identifies the product by the bar code and then either adds the product to the computer inventory accounting system or removes it from the computer inventory accounting system. This bar code system allow businesses to accurately and reliably maintain a dynamic inventory of their products.

There are a number of different variations of bar codes. UPC symbols are used on grocery store items, books, CDs, and magazines. UPC symbols are fixed in length and mandatory in the retail channel. Code 3 of 9 (“Code 39”) is used in video rental stores, on ID cards, and for labels. Code 128 is a compact symbology used by the shipping industry. Codabar is used in libraries and Interleaved 2 of 5 is used on corrugated boxes and in labels. PDF417 is an example of a new generation, high-density, non-linear symbology within the classification of two dimensional (“2D”) symbologies. The PDF417 encodes up to 1108 bytes of information which enables the protocol to provide real data instead of only being a pointer into an external database. Thus, instead of providing only a unique identification number of 12 digits, the PDF417 symbol can provide a text description of the product, the date of creation and the manufacturer.

A typical scanner which reads bar codes comprises a red laser emitting light at a specific frequency to distinguish the edges within a symbol. When the laser strikes a black band within the bar code, the light is not reflected. However, when the laser strikes a white space between the bands, it registers the signal. As an alternative to lasers, LED or CCD devices may be effectively utilized. Bar codes can be scanned omnidirectionally. The firmware in most scanners can decode more than one type of bar code. Each symbology has a unique start bar and stop bar at the beginning and end of the symbol, or some other unique pattern that allows the scanner to automatically discriminate between symbologies without human intervention.

Before the implementation of bar code scanners and the development of a standardized system, businesses had to keep their inventory on paper or manually input their products into a computer database. This system was cumbersome, time consuming, and was often inaccurate because of human error. Because of the time consumed with the manual input method it required companies to limit the number of items in their inventory, or hire many people to perform data input in order to keep up with the requirement of moving products in and out of their inventory.

Presently, when consumers wish to record the books they have read, videos they have viewed, or music compact discs purchased, they must keep a written ledger and then check the written ledger with the new items they are considering to purchase or rent. By comparing the new product with the list of previously used products consumers can determine if they have already used the product. This pencil and paper ledger method is cumbersome, unreliable, and time consuming.

Alternatively, consumers may utilize electronic personal information managers (“PIMs”) to maintain a database on goods and products they have purchased. These PIMs are widely available under the brand names of 3COM's PalmPilot® and Microsoft's Windows CE® devices. However, while the PIMs might do away with the written recordation of the data and provide the convenience of electronic data storage, the current PIMs still suffer from the laborious entry of each item description. Furthermore, the manual entry of a wide array of products is prone to human error.

Previous attempts have been made to utilize standardized bar codes for use by the consumer such as described in U.S. Pat. No. 5,424,524 to Ruppert et al. ('524 patent); which is incorporate herein by reference. The '524 patent describes a personal scanner for displaying shopping lists and scanning bar codes to assist shoppers. The '524 patent contemplates the consumer establishing a data path to the store prior to shopping and downloading a database of prices and product descriptions corresponding to the bar code symbols. The '524 patent also describes a shopping list database wherein items may be added or removed as desired. However, the '524 patent does not provide for a personal inventory system that records purchased or rented items across a broad range of categories.

Consequently, there is a need in the art for a personal inventory system that utilizes one or more bar code standards for rapid storage and retrieval of unique product identification codes.

There is a further need in the art for a personal production evaluation system that allows the user to quantify the quality of the purchased or rented product in order to decide whether to repeat the purchase or rental in the future.

However, in view of the prior art in at the time the present invention was made, it was not obvious to those of ordinary skill in the pertinent art how the identified needs could be fulfilled.

### SUMMARY OF THE INVENTION

The present invention enables consumers of products to maintain a personal inventory of the products they have used or purchased. This inventory enables the consumer to determine whether they wish to repurchase or reuse the product. For example, a consumer may use the invention to scan in the bar codes of books they have read and store the codes in non-volatile memory (“NVM”). When the consumer is selecting new books to read, he can scan the bar codes of the new books and have the device determine if the bar codes of the new books have already been scanned in the device, thus alerting the consumer that he has already purchased, and likely read the same book.

In a preferred embodiment of the invention, the product bar codes of purchased or rented items are stored into memory. At a later time, the bar code of the same item is scanned. If a match is found in memory, the device will alert the consumer by either audible or visual means, that the item has already been used, purchased, or rented.

In an alternate embodiment, the device may be used to store bar codes for other individuals. For example, if a consumer has several relatives for whom he purchases gifts, the consumer may scan in and store the bar codes for items purchased for each relative. At a later date, when the consumer wishes to purchase additional gifts for that individual, the device will forewarn the consumer from purchasing an identical item.

The device is not limited to only determining which items a consumer does not want to duplicate, but also which items he wishes to repurchase. For example, a consumer may like a certain brand of coffee, so in order to accurately repurchase the same brand, he would scan in the various brands of coffees until he obtained a signal from the device that indicates a match has been found.

Thus, the invention herein provides for a bar code scanning apparatus for maintaining a personal inventory, comprising a read-only memory module for storing a computer program and data, a microprocessor coupled to said read-only memory module and able to execute the computer program, a user input interface coupled to the microprocessor for receiving input and transmitting signals. A bar code scanner coupled to the microprocessor scans bar codes and converts each bar code to the corresponding string of characters encoded within the bar code which can be stored by the microprocessor.

The computer program records scanned bar codes into a non-volatile memory module, and previously recorded bar codes in the non-volatile memory module are compared to newly scanned bar codes. If a match is determined, the apparatus activates a signal device transmit the results of the comparison. The signal device may comprise an audio speaker that emits a simple sound or may comprise an audio speaker controlled by a voice synthesis circuit coupled to the microprocessor. Alternatively, the signal device may comprise an alphanumeric display. The associated text displayed on the alphanumeric display may by manually entered by the user via a keypad integrated into the bar code scanning apparatus or through a communications interface with a computer.

Alternatively, certain bar code symbologies such as PDF417 may encode alphanumeric information on the associated product, and therefore may be recorded in the non-volatile memory without user intervention. In a preferred embodiment the computer program is able to resolve a plurality of bar code symbologies and identify the symbologies without user intervention.

Accordingly, it is an object of the present invention to provide a device that allows consumers to identify which items they wish to purchase, and which items have already been purchased without keeping track of the inventory by manual entry. This invention makes it easier, faster, and more reliable than the prior method of keeping manually entered records.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF THE DRAWINGS

For a fuller understanding of the nature and objects of the invention, reference should be made to the following detailed description, taken in connection with the accompanying drawings, in which:

FIG. 1 is a diagrammatical view of the invention.

FIG. 2 is a flowchart of the operation of the invention.

FIG. 3 is a front elevational view of an embodiment of the invention.

FIG. 4 is a front elevational view of an alternative embodiment of the invention.

### DETAILED DESCRIPTION OF THE PREFERRED EMBODIMENT

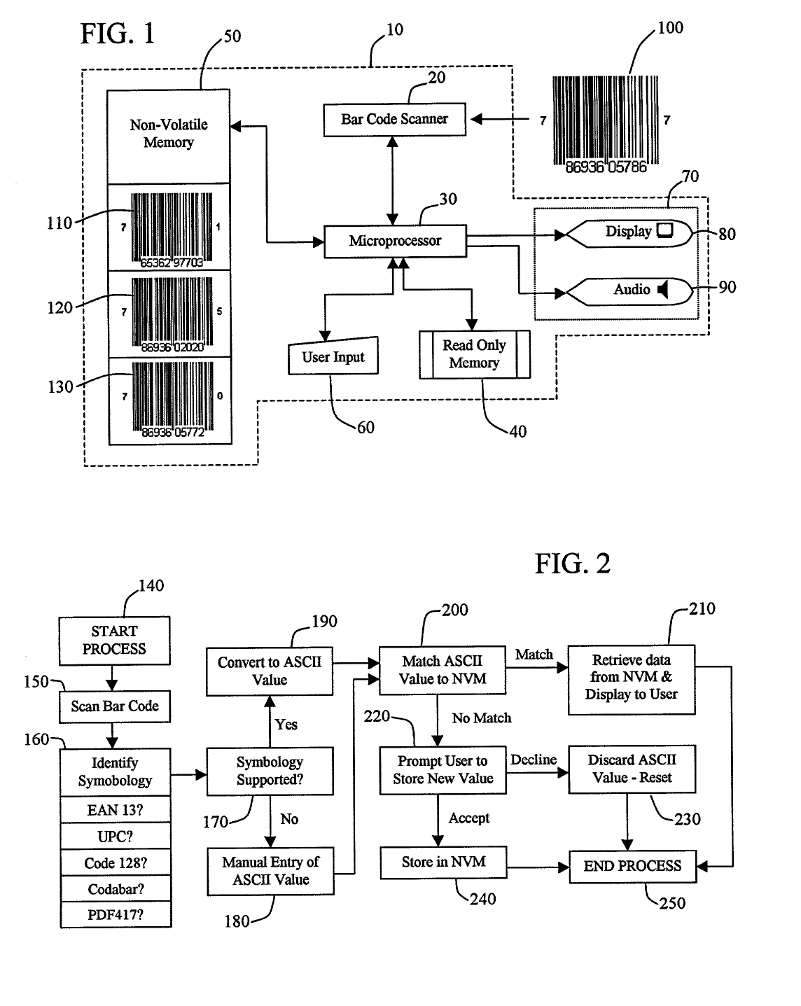

Referring initially to FIG. 1, it will there be seen that an illustrative embodiment of the present invention is denoted by the reference number 10 as a whole wherein the invention comprises a bar code scanner 20 capable of reading at least one type of bar code symbology coupled to a microprocessor 30. As an example, a target bar code 100 utilizes the UPC symbology. The microprocessor 30 interfaces with a non-volatile memory module 50 capable of storing an array of bar code values 110, 120 and 130. A user input interface 60 sends information to the microprocessor 30. The microprocessor 30 is controlled by software stored in a read-only memory module 40. Output information is sent from the microprocessor 30 to a signal device 70, which may comprise a display 80 or an audio speaker 90. The display 80 may comprise a simple light emitting diode (“LED”) or a liquid crystal configuration. Higher-end models may employ flat panel displays similar to notebook computers or plasma displays. The audio speaker 90 may provide a voice-synthesized output that identifies the ASCII value of the bar code, or preferably, a description of the associated product.

FIG. 2 illustrates the operation of the invention. A target bar code 100 is read 150 by the bar code scanner 20. Software stored in the read-only memory module 40 attempts to identify 160 the symbology of the target bar code 100 and then determines if that symbology is supported 170. If the symbology is supported in the read-only memory module 40, the vertical lines of the target bar code 100 are converted to an ASCII value 190. If the symbology of the target bar code 100 is not supported by the read-only memory module 40, then the user may manually enter the numerical ASCII code 180 via the user input interface 60. Once an ASCII value has been resolved, either by automated 190 or manual entry 180, the ASCII value is then correlated 200 to any matching values in the non-volatile memory module 50. If a match is found, the microprocessor 30 retrieves the data from the non-volatile memory module 50 and displays the data to the user 210. If no match is found between the target bar code 100 ASCII value and the values in the non-volatile memory module 50, the user is prompted whether to store the new value 220. If the user declines to store the new ASCII value, that value is discarded 230 and the program sequence is reset. However, should the user accept the new ASCII value of the target bar code 100, the new value is stored in the non-volatile memory module 50.

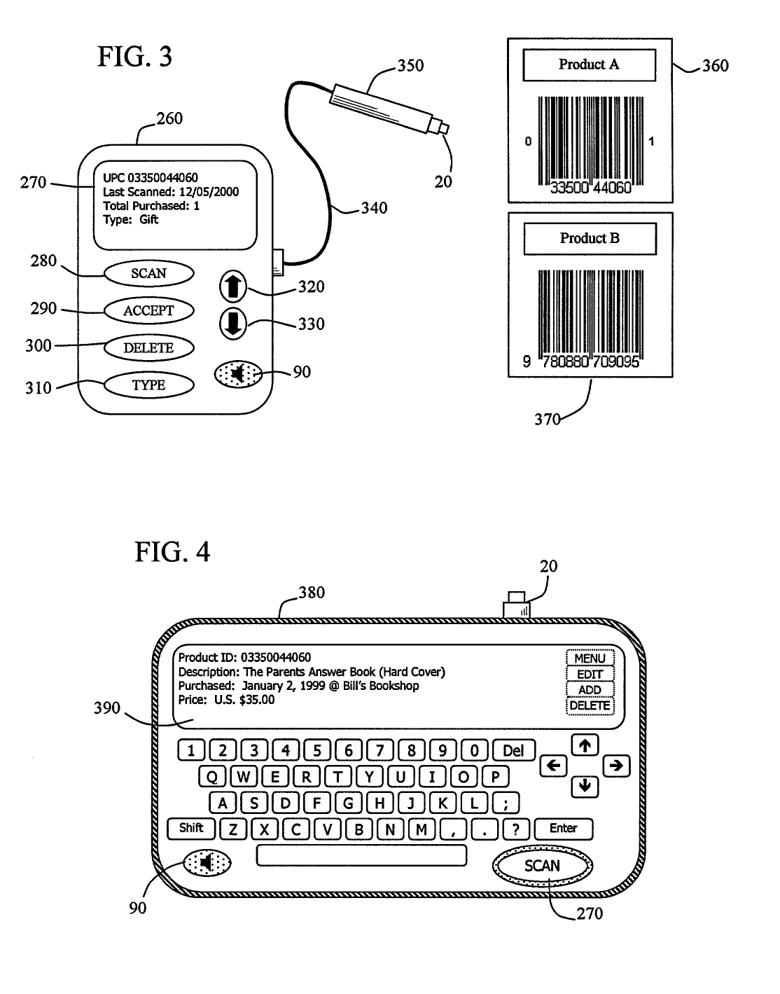

FIG. 3 illustrates an embodiment of the invention wherein a compact housing 260 comprises a liquid crystal display 270 capable of displaying alphanumeric characters. A bar code scanner 20 is coupled to an elongated cylinder 350 and communicates data scanned to said housing via an connection wire 340. A scan button 280 activates the bar code scanner 20 to read a bar code. In a preferred embodiment of the invention, the read-only memory module 40 and microprocessor 30 are capable of resolving a plurality of bar code symbologies such as the UPC symbology found on Product A 360 and the EAN 13 symbology found on Product B 370. Once a bar code is scanned, the user may press the accept button 290 to store the ASCII value in the non-volatile memory module 50 or may decline the entry by pressing the delete button 300. The type button 310 may be utilized to provide a description or category of the scanned item such as video, book, gift or the like. An up arrow button 320 and a down arrow button 330 provide navigation and control of the software interface. As an option, an audio speaker 90 is provided for audible feedback. Alternatively, the audio speaker 90 may be utilized, particularly for persons with visual disabilities, to describe the scanned item by a voice synthesis circuit.

In a more sophisticated embodiment shown in FIG. 4, a keypad is provided within a palm-top housing 380. A visual display 390 provides descriptive information on the products stored in memory and may contain additional data fields such as price paid, date purchased, store of purchase, an evaluation of the product, and the like. To reduce the number of breakable parts and further compact the design, the bar code scanner 20 is integrated into the palm-top housing 380. An audio speaker 90 and scan button 270 are also integrated into the palm-top housing 380.

It will be seen that the objects set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

What is claimed is:

1. A bar code scanning apparatus for maintaining a personal inventory, comprising:
a read-only memory module for storing a computer program and data;
a microprocessor coupled to said read-only memory module and able to execute said computer program;
a user input interface coupled to said microprocessor for receiving input and transmitting signals;
a bar code scanner coupled to said microprocessor for scanning bar codes and converting each bar code to the corresponding string of characters encoded within said bar code which are stored in a non-volatile memory module; and
a signal device whereby previously recorded bar codes in said non-volatile memory module are compared to newly scanned bar codes and said signal device is activated to transmit the results.

2. The apparatus of claim 1, wherein said signal device comprises an audio speaker.

3. The apparatus of claim 1, wherein said signal device comprises an audio speaker controlled by a voice synthesis circuit coupled to said microprocessor.

4. The apparatus of claim 1, wherein said signal device comprises an alphanumeric display.

5. The apparatus of claim 1, wherein said computer program is able to resolve a plurality of bar code symbologies.

6. The apparatus of claim 1, wherein said non-volatile memory stores alphanumeric descriptions of previously scanned bar codes, said alphanumeric descriptions provided by a compatible bar code symbology capable of encoding said alphanumeric descriptions.

7. The apparatus of claim 1, wherein said non-volatile memory stores alphanumeric descriptions of previously scanned bar codes, said alphanumeric descriptions being stored by manual entry into said user input interface.

8. The apparatus of claim 1, further comprising a communications interface for exchanging information stored in said non-volatile memory module to an external computer.

9. The apparatus of claim 1, wherein said non-volatile memory stores user defined product evaluations associated with the bar codes of selected products.

10. A bar code scanning apparatus for maintaining a personal inventory, comprising:
a read-only memory module for storing a computer program and data;
a microprocessor coupled to said read-only memory module and able to execute said computer program capable of resolving a plurality of bar code symbologies;
a user input interface coupled to said microprocessor for receiving input and transmitting signals including alphanumeric descriptions of scanned bar codes and corresponding product evaluations;
a bar code scanner coupled to said microprocessor for scanning bar codes and converting each bar code to the corresponding string of characters encoded within said bar code which are stored in a non-volatile memory module;
a signal device comprising an alphanumeric display and an audio speaker controlled by a voice synthesis circuit coupled to said microprocessor;
a communications interface for the exchange of data stored in said non-volatile memory module to an external computer;
whereby previously recorded bar codes in said non-volatile memory module are compared to newly scanned bar codes and said signal device is activated to transmit the results.
